(19) United States
(12) Patent Application Publication
(10) Pub. No.: US 2014/0028023 A1
(43) Pub. Date: Jan. 30, 2014

(54) SIGNAL TRANSMISSION SYSTEM FOR A WIND ENERGY SYSTEM AND METHOD FOR TRANSMITTING SIGNALS IN A WIND ENERGY SYSTEM

(71) Applicant: Stephan KLÜMPER, Gronau/Westfalen (DE)

(72) Inventor: Stephan KLÜMPER, Gronau/Westfalen (DE)

(21) Appl. No.: 13/559,962

(22) Filed: Jul. 27, 2012

(51) Int. Cl. H02P 9/04

(52) U.S. Cl. 290/44

(57) ABSTRACT

A wind energy system is described including a nacelle, a rotor rotatably connected to the nacelle, and a power line for transmitting electrical energy between the nacelle and the rotor. The power line includes a transmitting device between the rotor and the nacelle. Further, the wind energy system also includes a first modulation device connected to the power line at a nacelle facing side of the power line for modulating and demodulating signals to be transmitted via the transmitting device, and a second modulation device connected to the power line at a rotor facing side of the power line for modulating and demodulating signals to be transmitted via the transmitting device. Further, a signal transmission system for a wind energy system and a method for establishing a signal transmission system in a wind energy system are provided.

### BACKGROUND OF THE INVENTION

The subject matter described herein relates generally to methods and systems for transmitting signals in a wind energy system, and more particularly, to methods and systems for transmitting signals between the rotor of a wind energy system and the nacelle of a wind energy system.

At least some known wind turbines include a tower and a nacelle mounted on the tower. A rotor is rotatably mounted to the nacelle and is coupled to a generator by a shaft. A plurality of blades extends from the rotor. The blades are oriented such that wind passing over the blades turns the rotor and rotates the shaft, thereby driving the generator to generate electricity.

Often, operational parameters of the rotor are controlled by control signals coming from a control unit in the nacelle. Further, the control unit in the nacelle often receives information and data from the rotor. In order to be able to control the electrical system of the rotor, a bus communication is installed between the rotor and the nacelle. The bus communication typically allows for exchanging information between the rotor and the nacelle. For instance, reference values or control parameters, as well as measured and actual values, are transferred from the rotor to the nacelle and vice versa.

The rotor and the nacelle are often electrically connected by a slip ring between them. The slip ring has a rotating part and a non-rotating or stationary part. As known in the art, individual communication lines between the nacelle and the rotor are provided within a slip ring for ensuring the information transfer. However, the communication lines are often influenced by electrical noise, damage, wear and dirt. Due to the nature of communication signals, they are running on low voltage, which makes them very sensitive for transfer and/or contact resistance. This often leads to communication faults.

Thus, it is desirable to provide a bidirectional signal transmission between the rotor and the nacelle, as well as between the nacelle and the rotor of a wind energy system, which is stable and reliable although the transmission is performed from a rotating part to a stationary part of the wind turbine.

### BRIEF DESCRIPTION OF THE INVENTION

In one aspect, a wind energy system is provided. The wind energy system may include a nacelle, a rotor rotatably connected to the nacelle, and a power line for transmitting electrical energy between the nacelle and the rotor, wherein the power line is associated with a transmitting device between the rotor and the nacelle. Further, the wind energy system described herein includes a first modulation device connected to the power line at a nacelle facing side of the power line for modulating and demodulating signals to be transmitted via the transmitting device, and a second modulation device connected to the power line at a rotor facing side of the power line for modulating and demodulating signals to be transmitted via the transmitting device.

In another aspect, a signal transmission system for a wind energy system is provided. The wind energy system may include a nacelle, a rotor rotatably connected to the nacelle, and a transmitting device for transmitting electrical power between the nacelle and the rotor. Typically, the transmission system includes a first power line for transferring electrical energy in the nacelle of the wind energy system, connected to the transmitting device, and a first modulation device at the first power line for modulating and demodulating signals to be transmitted via the transmitting device. Further, the transmission system may include a second power line for transferring electrical energy in the rotor of the wind energy system, connected to the transmitting device, and a second modulation device at the second power line for modulating and demodulating the signals to be transmitted via the transmitting device.

In yet another aspect, a method of transmitting signals in a wind energy system is provided. The wind energy system may include a nacelle, a rotor rotatably connected to the nacelle, and a power line for transmitting electrical energy between the nacelle and the rotor. Typically, the method of transmitting signals includes modulating a signal, transmitting the modulated signal via the power line between the nacelle and the rotor, and demodulating the transmitted signal.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is an exposed and enlarged sectional view of a nacelle and a rotor of a wind turbine having a transmitting device according to embodiments described herein;

FIG. 4 is a schematic, partly exploded view of a part of a wind turbine having a signal transmission system in the nacelle and the rotor of the wind turbine according to embodiments described herein;

FIG. 5 is a schematic view of a part of a wind turbine having a signal transmission system in the nacelle and the rotor of the wind turbine according to embodiments described herein;

FIG. 6 is a schematic view of a part of a wind turbine having a signal transmission system in the nacelle and the rotor of the wind turbine according to embodiments described herein;

FIG. 7 is a schematic view of part of a wind turbine having a signal transmission system in the nacelle and the rotor of the wind turbine according to embodiments described herein;

FIG. 8 is a schematic view of a signal transmission system according to embodiments described herein;

FIG. 9 is a flow chart for a method of establishing a signal transmission system in a wind turbine according to embodiments described herein;

FIG. 10 is a flow chart for a method of establishing a signal transmission system in a wind turbine according to embodiments described herein; and,

FIG. 11 is a flow chart for a method of establishing a signal transmission system in a wind turbine according to embodiments described herein.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

Generally, within a wind turbine there is a desire to transmit electrical energy over a rotating transmitting device like a slip ring unit from electrical cabinets in the nacelle to the hub. Additionally, it is desirable to control the hub electrical system by means of electrical bus communication. In wind turbines as known in the art, the signal and power path is independent and transmitted via individual paths. However, this way of transferring communication signals is error-prone due to electrical noise, damage, wear and dirt. To solve the problem, some wind turbines rely on using contactless communication established with infrared and inductive transmitting lines.

According to embodiments described herein, signal transmission between the nacelle and the rotor of a wind turbine is combined with the power path. The embodiments described herein include a wind turbine system that allows for a reliable and stable signal transmission from rotating parts of the wind turbine to stationary parts of the wind turbine and vice versa. More specifically, a signal transmission path between rotating and stationary parts of the wind turbine is used which results in a better communication signal quality. In addition, less failure messages, shorter downtime and fewer unplanned and planned service actions can be achieved by using the signal transmission system in a wind turbine according to embodiments described herein.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power. Further, as used herein, the term “transmitting device” is intended to be representative of a device being capable of transmitting electrical power between parts of a wind turbine. For instance, a transmitting device may be able to transmit power between rotating parts of a wind turbine and non-rotating parts of a wind turbine, such as from the nacelle to the rotor and vice versa. In particular, a transmitting device may be connected to a power line, which feeds the electrical power to the respective part of the wind turbine via the transmitting device.

Typically, a “modulation device” as used herein should be understood as a device being capable of modulating and/or demodulating signals to be transmitted via a power line. For instance, a modulation device may receive signals transmitted via a communication system, such as a bus communication system, ethernet, canbus, profibus or any protocol suitable for the signal communication. Typically, the modulation device may modulate signals to be transferred via a power line. Typically, the signals to be modulated may concern control signals, measured values, reference values and the like.

Generally, a “nacelle-facing side” of the power line may be understood as a part of the power line running through the nacelle. For instance, the nacelle-facing side of the power line includes the part of the power line running through the nacelle to a transmitting device. In the same manner may a rotor-facing side of a power line be understood. The rotor-facing side of a power line typically includes the part of the power line running through the rotor. For instance, the rotor-facing side of a power line may be the part of the power line running through the rotor to the transmitting device. Typically, the term “running through” should not be understood so that a line running through a component of a wind turbine necessarily exits the component of the wind turbine. In one embodiment described herein, the rotor-facing side and the nacelle-facing side of the power line include the part of the power line being connected to the transmitting device. According to some embodiments, the nacelle-facing side and the rotor-facing side of the power line describe parts of the power line as being near (such as within typically between about 0 m to 3 m, more typically between about 0 m and 2 m, and even more typically between about 0 m and 1 m) the location where the power line is connected to the transmitting device.

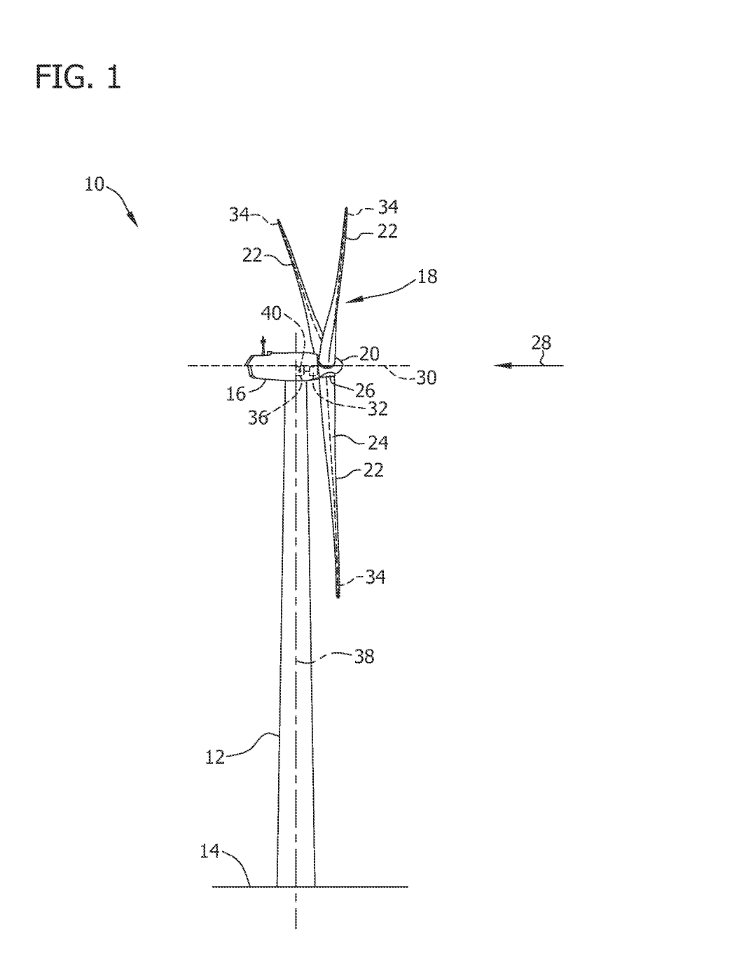

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change the blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DC S) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

In the exemplary embodiment, the controller is a real-time controller that includes any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, controller 102 may be a microprocessor that includes read-only memory (ROM) and/or random access memory (RAM), such as, for example, a 32 bit microcomputer with 2 Mbit ROM, and 64 Kbit RAM. As used herein, the term “real-time” refers to outcomes occurring over a substantially short period of time after a change in the inputs affect the outcome, with the time period being a design parameter that may be selected based on the importance of the outcome and/or the capability of the system processing the inputs to generate the outcome.

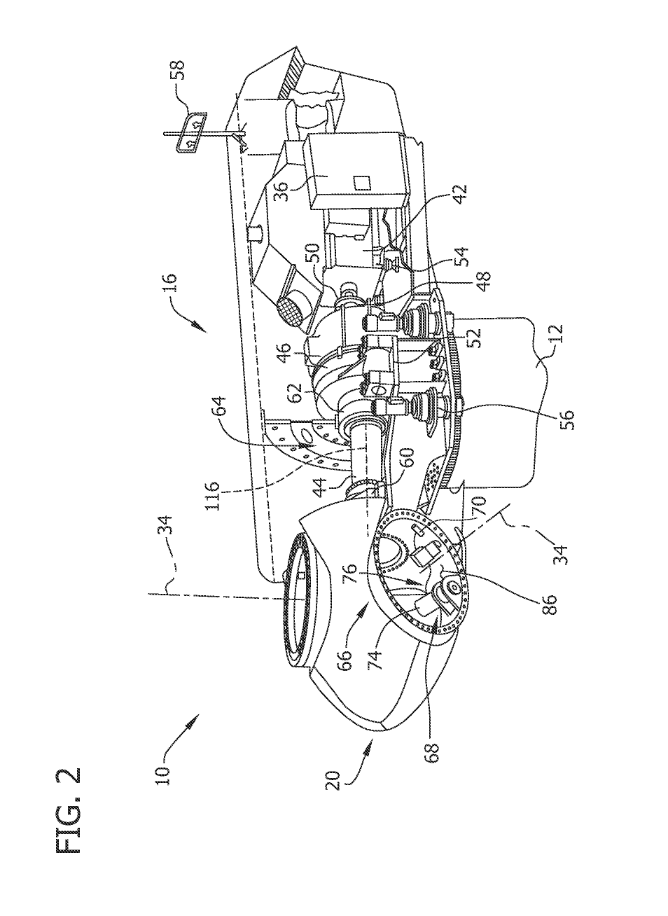

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 which subsequently drives high speed shaft 48. High speed shaft 48 rotatably drives generator 42 with coupling 50 and rotation of high speed shaft 48 facilitates the production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68 and at least one sensor 70. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

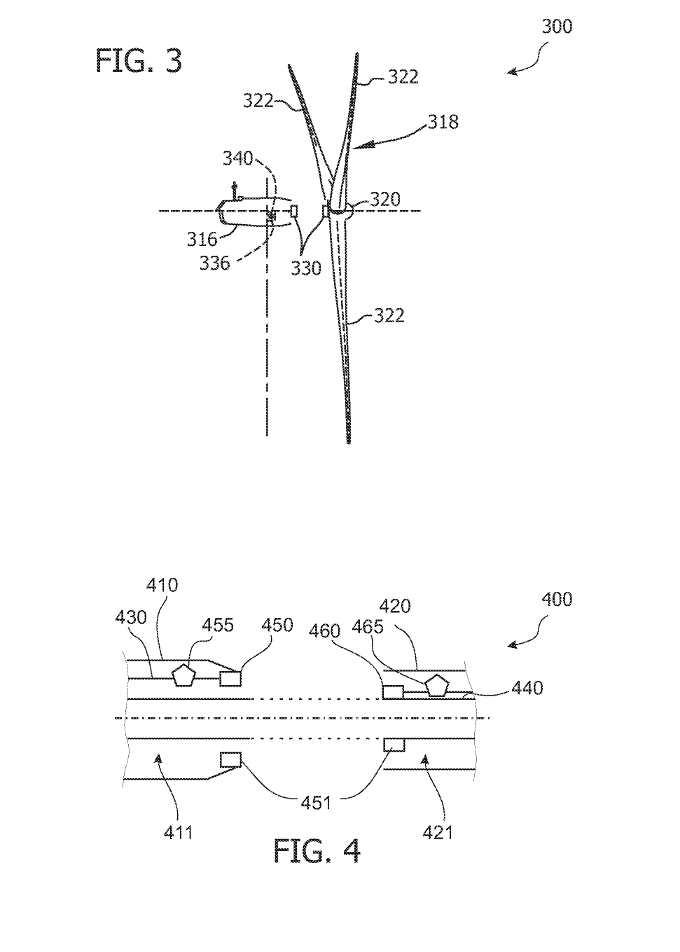

FIG. 3 shows an exploded schematic view of a wind turbine 300 according to embodiments described herein. Typically, a transmitting device 330 is provided between the nacelle 316 and the rotor 318 for transmitting electrical power between the nacelle 316 and the rotor 318 of the wind turbine. According to some embodiments described herein, the power transmission between nacelle 316 and rotor 318 via transmitting device 330 may be used for providing electrical power to the rotor hub 320, for instance, for supplying power to a pitch adjustment system (as for instance described above with respect to FIG. 2), for supplying power to a light device in the rotor blades 322 or the rotor hub 320, such as a navigation light or a light connection for maintenance services.

According to some embodiments, the nacelle 316 further includes a control system 336 and a processor 340, such as a control system and a processor as described above. Typically, the transmitting device 330 may directly or indirectly be connected to the control system 336, for exchanging information and data between the control system 336 and the transmitting device 330, for instance.

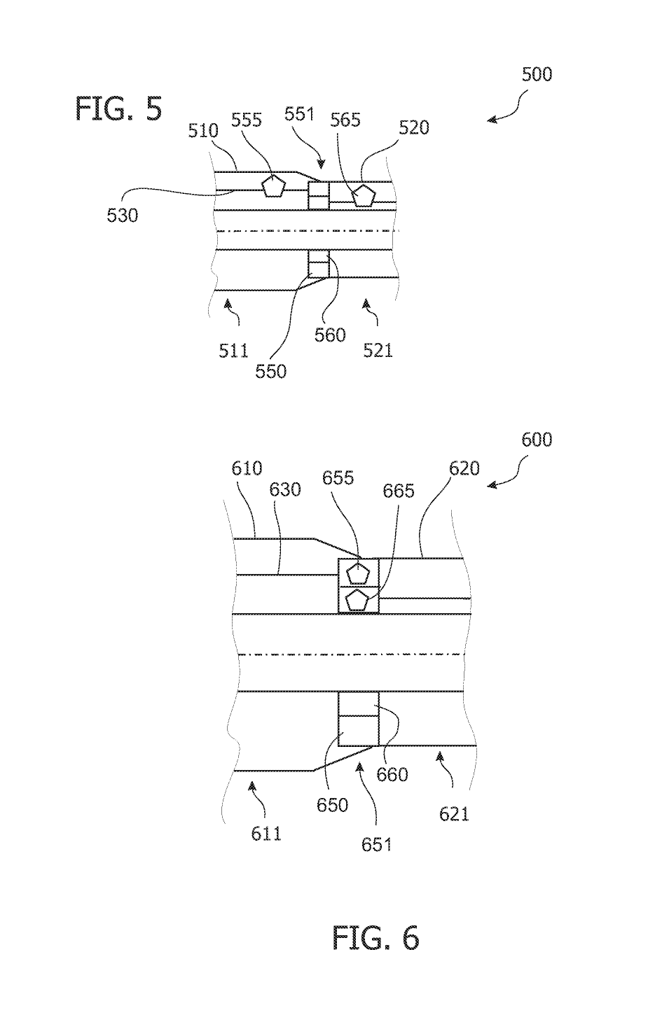

FIG. 4 shows an exploded view of the location between the nacelle 410 and the rotor 420 of a wind turbine 400 (of which only a part is shown in FIG. 4). The parts are shown drawn apart for the sake of a better overview. The dashed lines show the lines along which the exploded shown parts are assembled together. An assembled view is also shown in FIG. 5, which is explained in more detail below. Typically, the wind turbine 400 may be a wind turbine as shown in FIG. 3. According to some embodiments, the wind turbine 400 includes a power line 430 for transmitting power from the nacelle 410 to the rotor 420. Typically, the power line 430 includes a transmitting device 451 between the rotor 420 and the nacelle 410.

In FIG. 4, also the rotor shaft 440 is shown, which may be a shaft as exemplarily described with respect to FIG. 2. Typically, the rotor shaft 440 rotatably couples hub 20 to an electric generator (not shown) positioned within the nacelle 410.

According to some embodiments, the transmitting device 451 may include a component 460 at a rotor facing side 421 of the power line 430 and a component 450 at a nacelle facing side 411 of power line 430. Typically, the rotor facing side 421 of the power line 430 may be understood as the part of the power line 430 that runs through the rotor 420 or the rotor hub of the wind turbine 400. Typically, the power line 430 leaves the nacelle 410 at the transmitting device 451. It should be understood that the power line 430 runs through the rotor 420, when leaving the nacelle 410 at the transmitting device. According to some embodiments, the nacelle facing side 411 of the power line 430 may be understood as the part of the power line 430 that runs through the nacelle 410. It should be understood that the power line 430 runs through the nacelle 410, when leaving the rotor 420 at the transmitting device.

Typically, the components 450 and 460 of the transmitting device 451 may either be rotary or stationary. For instance, the component 450 at the nacelle facing side 411 of the power line 430 may be stationary and the component 460 at the rotor facing side 421 of the power line 430 may be rotary.

Typically, a first modulation device 455 is connected to the power line 430 at the nacelle facing side 411 of the power line 430. Further, a second modulation device 465 is connected to the power line 430 at the rotor facing side 421 of the power line 430. In other words, in embodiments of a wind turbine as described herein, a modulator/demodulator device is arranged on the rotor hub side (as a rotating part of the wind turbine) and on the nacelle side (as a stationary part of the wind turbine), and is connected to the power line. According to some embodiments, the modulation devices 455 and 465 may be used to modulate and demodulate signals to be transmitted via transmitting device 451 and power line 430. According to embodiments described herein, the signals may be transmitted between the rotor 420 and the nacelle 410 in a bidirectional way via the transmitting device 451. The signals may typically be supplied to the modulation devices 455 and 465 by signal lines (not shown). For instance, the signal lines may be connected to the control system of the wind turbine or to further devices, such as measurement equipment, processors, power consumers, or the like.

According to some embodiments, the modulation device 450 may be located at the power line 430 on the nacelle facing side 411 before the power line enters the transmitting device 430 on the nacelle facing side, as shown in FIG. 4. Further, the modulation device 465 may be located at the power line 430 at the rotor facing side 422 after the power line 430 leaves the transmitting device 451, as shown in FIG. 4.

Typically, the power line and/or the transmitting device are adapted for transmitting signals from a sensor of the rotor (such as a wind sensor), signals from a measurement device in the rotor (such as a velocity measurement device, or a pressure measurement device), signals including reference values of a control unit of the wind energy system (such as reference values for the velocity of the rotor), and control signals (such as signals able to influence the characteristic of the rotor operation, e.g., the velocity of the rotor, the pitch angle of the rotor blades, the light supply in the rotor and the like). According to some embodiments, the signals to be transmitted may also include signals for the diagnosis of the wind turbine operation or measurement devices for a prototype of a wind turbine.

For the purpose of transmitting control signals to several devices of the wind turbine, the modulation devices may typically be connected to the control system of the wind turbine. For instance, the control system may send information to the modulation device for influencing the signals to be transmitted via the power path and the transmitting device of the wind turbine. The control system and/or the processor may typically be able to calculate necessary measures for influencing an operating parameter of the rotor. According to some embodiments, the control system and/or the processor of the wind turbine may use information from the rotor transmitted via the transmitting device to calculate or determine (e.g., by using a look-up table) the measures to bring the operation parameters in a desired range.

Typically, the modulation devices may be adapted for modulating signals in the MHz-range. The power line and the modulation devices are typically adapted to handle communication signals sent to the modulation device via ethernet, canbus, profibus or any protocol suitable for the signal communication in a wind turbine.

FIG. 5 shows the arrangement shown in FIG. 4 in an assembled state. A power line 530 includes a nacelle-facing side 511 and a rotor-facing side 521. According to embodiments described herein, a transmission device 551 includes a first component 550 at the nacelle-facing side 511 of the power line 530 and a second component 560 at the rotor-facing side 521 of the power line 530. Typically, one of the first and second components 550 and 560 is rotary and the other one is stationary.

Typically, a first modulation device 555 is connected to the power line 530 at the nacelle facing side 511 of the power line 530. Further, a second modulation device 565 is connected to the power line 530 at the rotor facing side 521 of the power line 530. According to some embodiments, the first modulation device 555 and the second modulation device 565 may be modulation devices as described with respect to FIG. 4.

According to some embodiments, the transmitting device 551 including the components 550 and 560 may be a slip ring.

Typically, the power line of the wind turbine as described herein may be an auxiliary voltage line of the rotor. For instance, an auxiliary voltage line may be a line transmitting auxiliary voltage to components of the rotor, such as a light system or a pitch adjustment system, or may be an auxiliary voltage line for maintenance purposes. For instance, the power line described herein may be an auxiliary light connection providing 230V/16A. In a further embodiment, the auxiliary voltage line may be adapted for handling 400V, or voltages above 400V, such as 690V, or up to 1 kV. Generally, the power line as described herein may be an AC power line or a DC power line. According to some embodiments, the power line may also be described as the main power line between the nacelle and the rotor of the wind turbine.

FIG. 6 shows an embodiment of a part of a wind turbine 600 as described herein. The wind turbine has a nacelle 610 and a rotor 620. A power line 630 includes a transmitting device 651, which is able to transmit power between the rotor 620 and the nacelle 610 of the wind turbine 600. The transmitting device 651 may include a component 650 as a first nacelle-facing component and a component 660 as a rotor-facing component. Typically, the transmitting device 651 may be a transmitting device as described above with respect to FIG. 4.

In the embodiments shown in FIG. 6, a first modulation device 655 is arranged in the transmitting device 651 at the nacelle facing side 611 of the power line 530.

According to some embodiments, and as shown in FIG. 6, a second modulation device 665 is arranged in the transmitting device 651 at the rotor facing side 622 of the power line 630. When one or more modulation devices are arranged in the transmitting device 551, it may be understood that the modulation devices are part of the transmitting device 651. Typically, the modulation devices may nevertheless be connected to the power line 630.

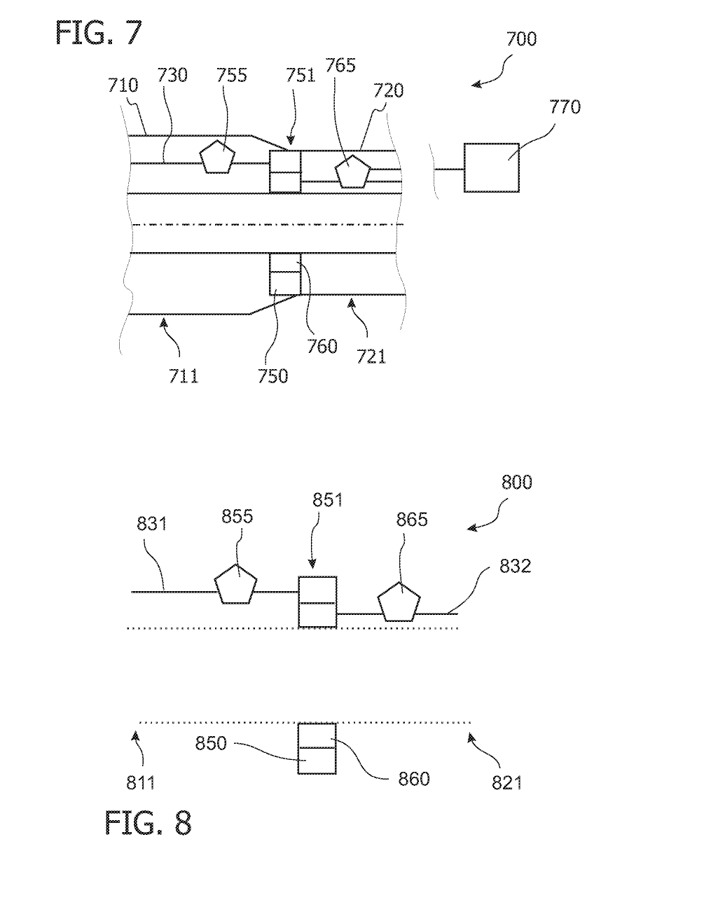

FIG. 7 shows an embodiment of a part of a wind turbine 700 including a nacelle 710 and a rotor 720. Typically, the components like a power line 730, a transmitting device 751 arranged at the power line 730, a first modulation device 755 at a nacelle-facing side 711 of the power line 730, and a second modulation device 765 at a rotor-facing side 722 of the power line 730 may be components as described with respect to FIGS. 3 to 6. Also, the arrangement of the components is a mere example and may be modified, as described in detail above.

Typically, as can be seen in FIG. 7, the modulation device 765 of the wind turbine is connected to components 770 of the rotor 720. According to some embodiments, the component 770 of the rotor 720 may be a sensor of the rotor, a measurement device in the rotor, a bus communication system of the rotor, a pitch adjustment system of the rotor or the like. Typically, the modulation device 760 of the wind turbine 700 may also be connected to the control unit of the wind turbine at the nacelle-facing side, as explained in detail above.

FIG. 8 shows a signal transmission system 800 for a wind turbine. According to some embodiments, the signal transmission system as described herein is adapted for being mounted in a wind turbine including a nacelle and a rotor rotatably connected to the nacelle (both not shown in FIG. 8). Typically, the transmission system 800 includes a transmitting device 851 for transmitting electrical power between the nacelle and the rotor.

According to some embodiments, the transmission system 800 may be described as including a first power line 831, which is able to transfer electrical energy in the nacelle of the wind turbine. Typically, the first power line 831 runs through the nacelle to the transmitting device of the transmission system. For instance, the first power line 831 is connected to the transmitting device 851. A first modulation device 855 is arranged at the first power line 831. As explained above, a modulation device as described herein is adapted for modulating and demodulating signals, such as measurement signals, control signals, and the like. Typically, the signals modulated and/or demodulated by the modulation device are transmitted between the rotor and the nacelle of the wind turbine via the transmitting device in a bidirectional way.

Typically, the signal transmission system 800 includes a second power line 832 for transferring electrical energy in the rotor of the wind turbine. According to some embodiments, also the second power line 832 is connected to the transmission device 851, similar to the first power line 831. Typically, the second power line 832 runs through the rotor of the wind turbine to the transmitting device 851 of the transmission system 800. Typically, a second modulation device 865 is arranged at the second power line 832. The second modulation device 832 may be similar or equivalent to the first modulation device 831 and may also be adapted for modulating and demodulating the signals to be transmitted via the transmitting device 851. The signals being modulated by the modulation device 865 may also include measurement signals, information about maintenance need, information about operation parameters and the like.

According to one embodiment described herein, the first modulation device 855 may be connected (such as directly or indirectly) with a control system or a processor of the wind turbine. In one embodiment, the first power line 831 may be connected to a power supply at one end and to the transmitting device 851 of the transmission system 800 at the other. Typically, the second power line 832 may be connected to the transmitting device 851 at one end and at some power consumer in the rotor at the other. For instance, the power consumer may be a pitch adjustment system, a light system or the like. Typically, the first power line 831, the second power line 832, and the transmitting device 851 between the first power line 831 and the second power line 832 may be described as being an auxiliary voltage line to the rotor of the wind turbine. For instance, the first power line 831 and the second power line 832 are adapted for supplying the rotor with power for an auxiliary light connection.

According to some embodiments, the first modulation device 855 is arranged at the first power line 831 in the transmitting device 851. In other words, the modulation device may be arranged in the transmitting device instead of at a location of the power line before the power line enters the transmitting device.

According to some embodiments, which can be combined with other embodiments described herein, the second modulation device 865 is arranged at the second power line 832 in the transmitting device 851. In other words, the modulation device may be arranged in the transmitting device instead of at a location of the power line, before the power line enters the transmitting device.

Typically, the first modulation device 855 and the second modulation device 865 are adapted for modulating and demodulating signals including frequencies in the MHz range. For instance, the modulation device s may be modulation devices as described with respect to the previous figures, especially FIG. 4.

Typically, the transmitting device 851 in FIG. 8 may be designed as the transmitting device described before. In one embodiment, the transmitting device 851 is a slip ring.

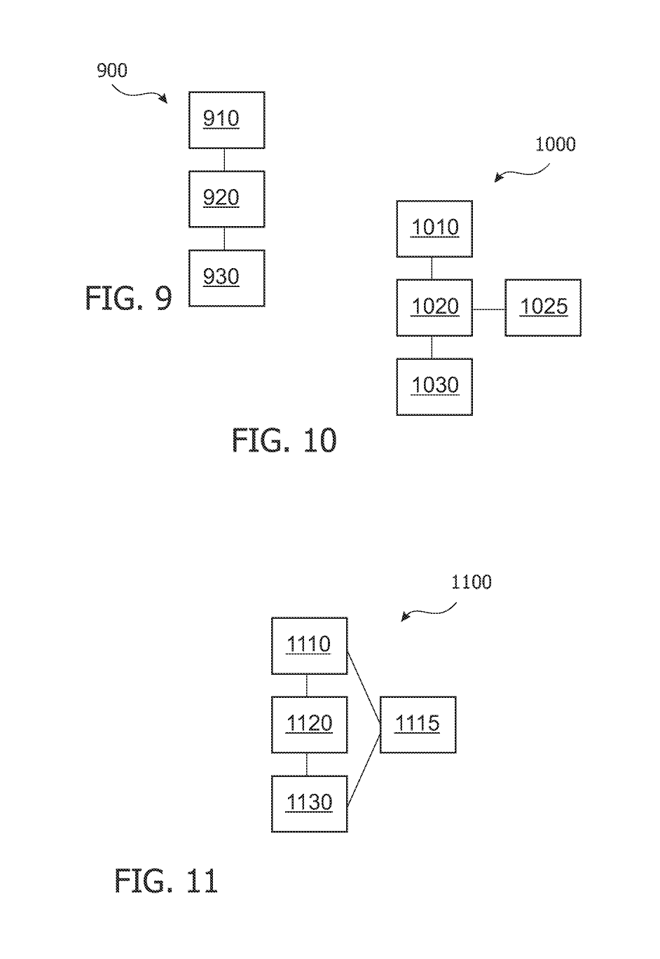

In FIG. 9, a flow chart of a method 900 of transmitting signals in a wind energy system according to embodiments described herein is shown. Typically, the wind energy system referred to in the description of methods of transmitting signals may be a wind energy system as described above. Typically, the wind energy system may have a rotor, a nacelle, and a power line for transmitting electrical energy between the nacelle to the rotor. According to some embodiments, the method 900 includes in block 910 modulating a signal. Typically, the signal may be modulated by a modulation device as described above. In one embodiment, the signal is modulated so as to be transmittable via a power line.

In block 920, the method 900 typically includes transmitting the modulated signal via the power line between the nacelle and the rotor. According to some embodiments, transmitting the modulated signals may include that the modulated signal is transmitted between the rotor and the nacelle in a bidirectional way.

Typically, the method 900 further includes block 930, in which the transmitted signal is demodulated. In one embodiment, the transmitted signal is demodulated in a modulation device, as exemplarily described in FIGS. 3 to 8.

According to some embodiments, which may be combined with other embodiments described herein, the method of transmitting signals in a wind energy system may further include transmitting the signal to be modulated from a control unit of the wind energy system to a modulation device. Typically, the modulation device is connected to or associated with the power line of the wind energy system, as described above with respect to FIGS. 3 to 8.

Typically, transmitting the modulated signal via the power line may include that the modulated signal is transmitted via a slip ring, which is connected to or associated with the power line. According to some embodiments, a signal is modulated by a modulation device, which may be arranged at the power line of the wind energy system near the slip ring or even in the slip ring. Also, the transmitted signal may be demodulated by a modulation device, which may be arranged at the power line of the wind energy system near the slip ring or even in the slip ring.

FIG. 10 shows an embodiment of the method 1000 of transmitting signals in a wind energy system. In method 1000, blocks 1010, 1020, and 1030 may correspond to blocks 910, 920, and 930 as described above, respectively. Typically, in method 1000 transmitting the signal further includes in block 1025 transmitting a signal, which may be a signal from a sensor of the rotor, a signal from a measurement device in the rotor, a signal including reference values of a control unit of the wind energy system, control signals or the like. As described above with respect to FIGS. 3 to 8, the signal may be modulated by a modulation device being connected to components of the wind energy system being able of providing signals, like the signals referred to in block 1025 of method 1000.

In FIG. 11, an embodiment of the method of transmitting signals is shown as method 1100. Typically, blocks 1110, 1120, and 1130 may correspond to blocks 910, 920, and 930 as described above, respectively. Method 1100 exemplarily includes block 1115. In block 1115, modulating the signal further is further specified by modulating the signal so as to include frequencies in the MHz range, Further, block 1115 includes demodulating the signal so as to include frequencies in the MHz range. For instance, the signal may be transmitted according to a bus protocol before being modulated as described herein. Typically, the signal may also be transmitted according to a bus protocol after being demodulated as described herein.

Further, an embodiment of a method of establishing a signal transmission system in a wind turbine is described. Block stands for establishing a transmission system in a wind turbine that includes a nacelle, a rotor rotatably connected to the nacelle, and a power line for transmitting electrical energy between the nacelle and the rotor. Typically, the power line includes a transmitting device between the nacelle and the rotor. According to some embodiments, the features described by block 910 may be designed as the features described with respect to FIGS. 3 to 8, such as the transmitting device 451, 551, 651, 751, 851 and the power line 430, 530, 630, 730, 830.

Typically, a first modulation device is connected to the power line of the wind turbine in the method of establishing a wind energy system. According to some embodiments described herein, the first modulation device is connected to the power line at a nacelle-facing side of the power line, as explained in detail above. Typically, a second modulation device is connected to the power line, but at the rotor-facing side of the power line.

In one embodiment, the method as described herein may also include arranging the first and/or second modulation device at the power line in the transmitting device. For instance, arranging the first and/or second modulation device in the transmitting device may be understood as arranging the first and/or second modulation device at the interface between power line and transmitting device or arranging the first and/or second modulation device at the power line at a location, where the power line has already entered the transmitting device.

A further embodiment of a method as described in the following. Typically, the method includes steps as described above. However, the method may further include transmitting signals between the rotor and the nacelle in a bidirectional way by transmitting signals modulated by the first modulation device and/or the second modulation device. According to some embodiments, the modulated signals are transmitted via the power line and the transmitting device. In one embodiment, transmitting signals is performed when the wind turbine is in an operating range. In a further embodiment, transmitting signals is performed during a test phase or a maintenance phase of the wind turbine.

According to some embodiments, the method further includes transmitting electrical power via the power line and the transmitting device during operation of the wind turbine, during mounting of the wind turbine, during a test phase of the wind turbine and/or during the maintenance of the wind turbine.

Typically, in an embodiment described herein, which may be combined with other embodiments described herein, the transmission of signals via the power line is specified by transmitting signals from a sensor of the rotor, signals from a measurement device in the rotor, signals including reference values of a control unit of the wind energy system and/or control signals via the power line and the transmitting device.

The above-described systems and methods facilitate a more reliable power signal transmitting path between the rotor and the nacelle. More specifically, embodiments described herein provide a signal transmission system in a wind turbine that provides more contact surface for the signal transmission. Using the embodiments as described above, a better communication signal quality will be reached.

Exemplary embodiments of a wind energy system, a signal transmission system, and a method of establishing a wind energy system are described above in detail. The systems and methods are not limited to the specific embodiments described herein, but rather, components of the systems and/or steps of the methods may be utilized independently and separately from other components and/or steps described herein. For example, the transmission system and the method for establishing a transmission system may be used in other settings, and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind energy system, comprising:
a) a nacelle;
b) a rotor rotatably connected to the nacelle;
c) a power line for transmitting electrical energy between the nacelle and the rotor, wherein the power line is associated with a transmitting device between the rotor and the nacelle;
d) a first modulation device connected to the power line at a nacelle facing side of the power line for modulating and demodulating signals to be transmitted via the transmitting device; and,
e) a second modulation device connected to the power line at a rotor facing side of the power line for modulating and demodulating signals to be transmitted via the transmitting device.

2. The wind energy system according to claim 1, wherein the first modulation device is arranged in the transmitting device at the nacelle facing side of the power line.

3. The wind energy system according to claim 1, wherein the second modulation device is arranged in the transmitting device at the rotor facing side of the power line.

4. The wind energy system according to claim 1, wherein at least one of the transmitting device and the power line are adapted for transmitting at least one of: signals from a sensor of the rotor, signals from a measurement device in the rotor, signals including reference values of a control unit of the wind energy system, and control signals.

5. The wind energy system according to claim 1, wherein at least one of the first modulation device and the second modulation device is connected to a control unit of the wind energy system.

6. The wind energy system according to claim 1, wherein the first and the second modulation devices are adapted for modulating and demodulating signals including frequencies in the MHz range.

7. The wind energy system according to claim 6, wherein the power line is adapted to transmit the signals including frequencies in the MHz range modulated by the modulation devices.

8. The wind energy system according to claim 1, wherein the power line is an auxiliary voltage line of the rotor.

9. The wind energy system according to claim 1, wherein the transmitting device is a slip ring.

10. A signal transmission system for a wind energy system including a nacelle, a rotor rotatably connected to the nacelle, and a transmitting device for transmitting electrical power between the nacelle and the rotor, the signal transmission system comprising:
a) a first power line for transferring electrical energy in the nacelle of the wind energy system, connected to the transmitting device;
b) a first modulation device at the first power line for modulating and demodulating signals to be transmitted via the transmitting device;
c) a second power line for transferring electrical energy in the rotor of the wind energy system, connected to the transmitting device; and,
d) a second modulation device at the second power line for modulating and demodulating the signals to be transmitted via the transmitting device.

11. The signal transmission system according to claim 10, wherein the first modulation device is arranged at the first power line in the transmitting device and the second modulation device is arranged at the second power line in the transmitting device.

12. The signal transmission system according to claim 10, wherein the first and the second modulation devices are adapted for modulating and demodulating signals including frequencies in the MHz range.

13. The signal transmission system according to claim 10, wherein the transmitting device is a slip ring.

14. The signal transmission system according to claim 10, wherein the first and the second power line are adapted for supplying power to the rotor for an auxiliary light connection.

15. A method of transmitting signals in a wind energy system, the wind energy system comprising a nacelle, a rotor rotatably connected to the nacelle, and a power line for transmitting electrical energy between the nacelle and the rotor, the method comprising:
a) modulating a signal;
b) transmitting the modulated signal via the power line between the nacelle and the rotor; and,
c) demodulating the transmitted signal.

16. The method according to claim 15, wherein transmitting the signal via the power line comprises transmitting the signal between the rotor and the nacelle in a bidirectional way.

17. The method according to claim 15, wherein transmitting the signal further comprises transmitting at least one of signals from a sensor of the rotor, signals from a measurement device in the rotor, signals including reference values of a control unit of the wind energy system and control signals.

18. The method according to claim 15, wherein modulating the signal further comprises modulating the signal comprising frequencies in the MHz range and wherein demodulating the signal further comprises demodulating the signal comprising frequencies in the MHz range.

19. The method according to claim 15, further comprising transmitting the signal to be modulated from a control unit of the wind energy system to a modulation device connected to the power line of the wind energy system.

20. The method according to claim 15, wherein transmitting the modulated signal via the power line comprises transmitting the modulated signal via a slip ring connected to the power line.
